(19) United States
(12) Patent Application Publication
(10) Pub. No.: US 2008/0184843 A1
(43) Pub. Date: Aug. 7, 2008

(54) Accelerator Pedal Module With Magnetic Sensor

(76) Inventors: Thomas Klotzbuecher, Rudersberg (DE); Bernhard Bauer, Althuette (DE); Sebastien Weiss, Fellbach (DE); Bernd Koeberle, Fellbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/817,632

(22) PCT Filed: Jan. 17, 2006
(86) PCT No.: PCT/EP2006/050244

§ 371 Date: Aug. 31, 2007

(30) Foreign Application Priority Data
Mar. 23, 2005 (DE) 10 2005 013 442.4

(51) Int. Cl. G05G 1/44

(52) U.S. Cl. 74/513

(57) ABSTRACT

The invention relates to an accelerator pedal module for controlling a drive motor power such as an internal combustion engine for a motor vehicle comprising a pedal lever pivotally maintained about an axis of rotation on a bearing bloc k The pivoting movement of the pedal lever with respect to the bearing block changes the direction of at least one magnetic field which change is converted into an electric signal by at least one sensor element and represents the pivoting angle of the pedal lever with respect to the bearing block. The magnetic field is generated by at least two bipolar magnets between which said sensor element is placed.

### PRIOR ART

The invention is based on an accelerator pedal module for controlling the power of a drive motor or engine, in particular an internal combustion engine of a vehicle, having a pedal lever held rotatably on a bearing block about a pivot axis, as generically defined by the preamble to claim 1.

From US Patent Application 2004/0041558 A1, a generic accelerator pedal module is known, having a Hall sensor as its rotary angle sensor, which as a function of the change in the magnetic field intensity generated by a single ring magnet modulates an electrical signal. The ring magnet is received in the pedal lever and is disposed coaxially with the pivot axis. The evaluation of the electrical signals modulated by the Hall sensors used there is done with a view to varying the field intensity of the magnetic field generated by the magnet. If for instance from play the pedal lever tilts relative to its pivot axis, then the magnetic field intensity varies, and thus so does the modulated electrical signal of the Hall sensor, even if the pedal lever was not actuated about its pivot axis. The magnetic field intensity that forms the measurement variable also varies with the temperature, so that temperature changes can lead to an incorrect outcome of measurement.

In European Patent Disclosure EP 1 182 461 A2, a sensor device with Hall elements is described, with the aid of which a change in the direction a magnetic field can be detected, in order to ascertain rotary angles of rotors of electric motors.

### ADVANTAGES OF THE INVENTION

It is proposed that the magnetic field be generated by at least two bipolar magnets, between which the sensor element is disposed, preferably symmetrically. This causes the magnetic fields generated by the respective magnets to act on the sensor element from different sides and to overlap and add together in an intersecting region, which brings about an advantageously high magnetic field intensity and high homogeneity of the magnetic field in the region of the sensor. A magnetic field of high homogeneity in the region of the Hall sensor has a favorable effect on the accuracy of measurement. By disposing the sensor element between the magnets, signal changes caused by tilting of the pedal lever relative to the pivot axis can furthermore be compensated for. These provisions therefore also make it possible for the location where the pedal lever is borne on the bearing block to be embodied with greater bearing play, and then for a friction lining, for generating the force hysteresis that is desired in accelerator pedals, to be disposed directly on the bearing faces. Last but not least, a temperature- or load-caused delay of parts of the accelerator pedal module has a reduced influence on the accuracy of the electrical signal modulated by the sensor. Overall, the measurement accuracy of the sensor element is thus increased, and a more-robust accelerator pedal module is the result.

The evaluation of the signals generated by the sensor element is furthermore done not with regard to a change in the magnetic field intensity but rather to the change in the direction of the magnetic field. The magnetic field direction does not change with fluctuating temperatures, and thus the electrical signals modulated by the sensor element of the accelerator pedal module of the invention are also for this reason independent of temperature fluctuations.

By the provisions recited in the dependent claims, advantageous refinements of and improvements to the invention defined by claim 1 are possible.

In a preferable way, the magnets are embodied as magnet disks and are magnetized diametrically with respect to a disk plane. Diametrical magnetization is understood to mean bipolar magnetization on each face end of the magnet disks.

Moreover, the magnet disks are disposed coaxially and parallel with respect to one another, and the center axes of the magnet disks are disposed coaxially with the pivot axis.

By experiments, Applicant has found that an especially homogeneous magnetic field is obtained if the magnet disks each have a recess on their side pointing toward the sensor element.

The sensor element preferably includes at least one integrated Hall IC, with Hall elements which are disposed parallel to or perpendicular to the magnet disks.

An especially compact structure is obtained if one magnet disk is received in each journal, pointing perpendicularly away from the pedal lever, of a shaft which is pivotably supported in the bearing block and is connected to the pedal lever in a manner fixed against relative rotation, The center axis of the shaft journals is then coaxial with the pivot axis.

To enable occupying the largest possible volume for generating a high magnetic field intensity within the circular cross sections of the two journals, the magnet disks, viewed for instance in cross section, have two circumferential surface portions, diametrically opposed to the magnet poles and embodied parallel to one another and rectilinearly and two are like circumferential surface portions disposed between them along the circumference.

The shaft may have a central recess, disposed between the shaft journals, into which recess the sensor element which is connected to the bearing block protrudes. The sensor element is then seated between the two shaft journals that carry the magnets, so that if the pedal lever tilts, while the angle between the magnetic field lines and the sensor element still changes as before, nevertheless because of the magnetic field action on both sides, these changes are largely compensated for.

An advantageous dual function of the shaft journals that support the magnet disks is obtained if one radially outer circumferential surface of shaft journal at the same time forms a bearing face of the pedal lever. To generate a pedal-force-dependent hysteresis, for instance at least a portion of the circumferential surface of the shaft journals is provided with a friction lining, which cooperates with an associated bearing face of the bearing block.

If the pedal lever is prestressed into its outset position by at least one spring element, which is braced by one end on the bearing block and on its other end on a bracing portion of the pedal lever, and a pressure element linearly guided in the tensing direction of the spring element is disposed in the bearing block between the bracing portion and the other end of the spring element, and a rolling face of the bracing portion can be rolled along the pressure element, then kinking of the spring element upon being tensed during a pedal actuation can be prevented. This is because the tension path of the spring element is predetermined by the linear compulsory guidance of the pressure element in the bearing block. The transverse forces that occur as the bracing portion rolls along the pressure element are then dissipated into the bearing block by the guides of the pressure element and are not transmitted to the spring element, which is then actuated in a manner free of transverse force. The pedal lever can then be embodied with a long lever arm on the bracing portion and with high spring element tension, in a small installation space.

In a further feature, the pressure element can be braced by the spring element against a stop in the outset position of the pedal lever, in such a way that essentially no spring forces act on the pedal lever. In the outset position of the pedal lever, the spring forces are consequently braced via the stop in the bearing block, which has the advantage that the mechanical load on the pedal lever and on its bearing in the bearing block is very slight; as a result, deformations that would affect the sensor signal are avoided, and the life of the accelerator pedal module is extended.

Last but not least, between the pressure element and the bearing block, two identical spring elements can be disposed parallel to one another, which makes it advantageously possible to use identical parts.

### DRAWINGS

One exemplary embodiment of the invention is shown in the drawings and described in further detail in the ensuing description. In the drawings

FIG. 1 shows a longitudinal cross section through an accelerator pedal module in a preferred embodiment;

FIG. 2 is a cross-sectional view taken along the line II-II in FIG. 1;

FIG. 3 is a cross-sectional view through a shaft journal of a pedal lever of the accelerator pedal module;

FIG. 4 is a cross-sectional view taken along the line IV-IV in FIG. 2;

FIG. 5 is a cross-sectional view taken along the line V-V in FIG. 1;

FIG. 6 is a schematic illustration of a magnetic field line course.

### DESCRIPTION OF THE EXEMPLARY EMBODIMENT

The accelerator pedal module 1 of the invention is used for controlling a drive motor or engine, preferably an internal combustion engine of a motor vehicle, whose throttle valve can be adjusted by a control motor. In this case, the accelerator pedal module 1 serves to generate electrical signals for the control motor, in order to control the power of the engine as a function of the position of a pedal lever 2 of the accelerator pedal module 1. However, the drive motor or engine may also for instance be an electric motor triggered by electrical signals.

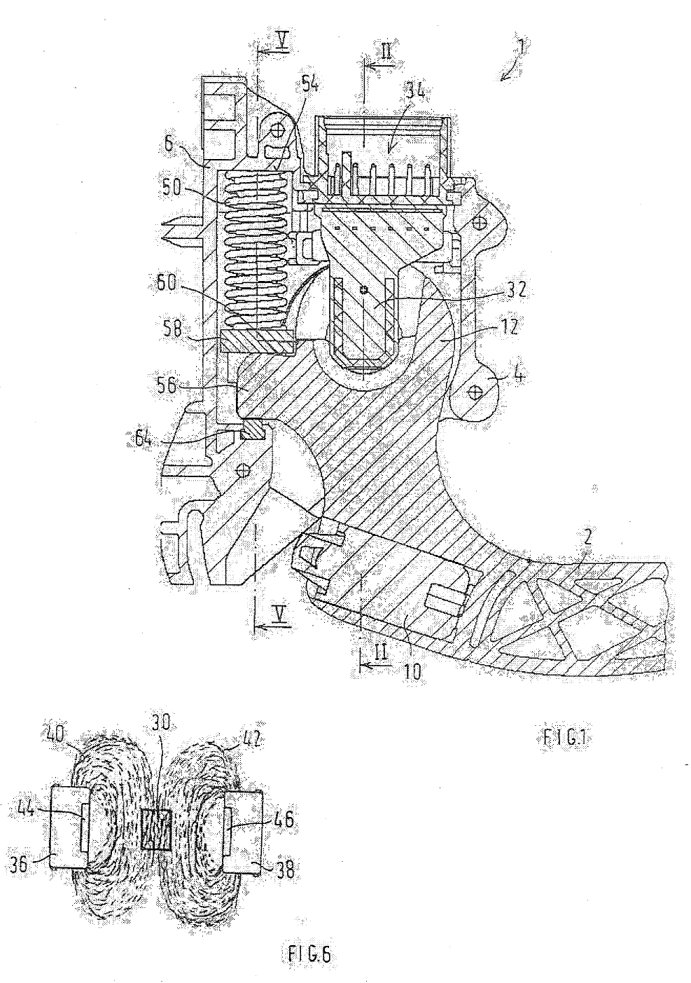

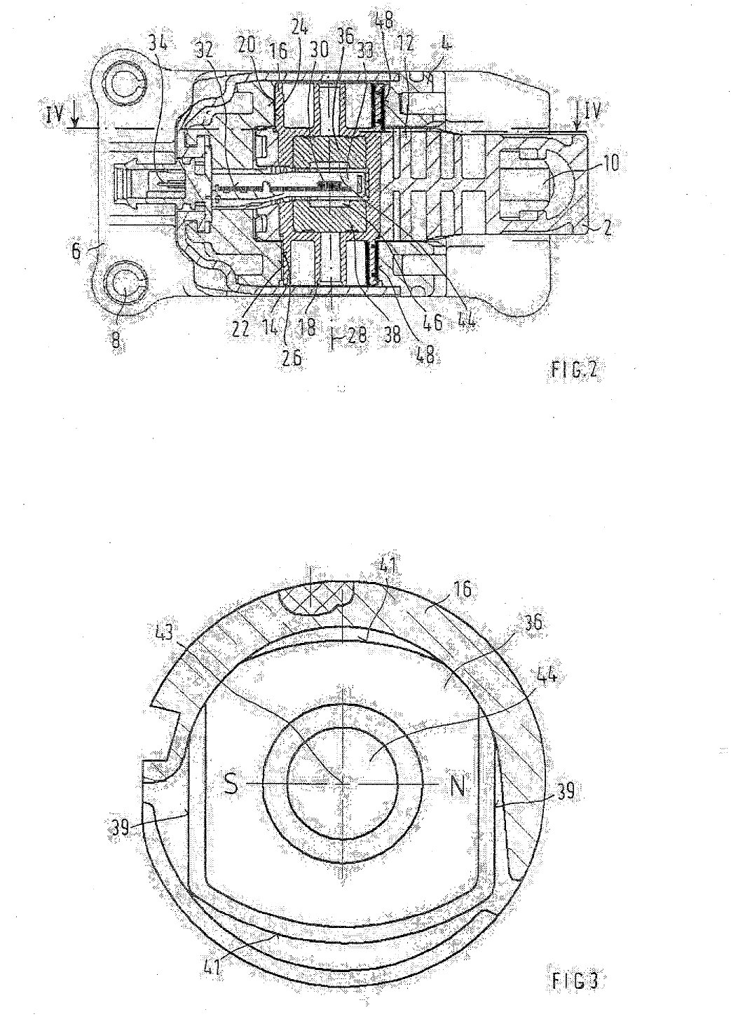

The accelerator pedal module 1 is foot-actuated by the driver of the motor vehicle and as shown in FIG. 1 includes the pedal lever 2, for instance suspended, which preferably represents the gas pedal actuated directly by the driver's foot. Alternatively, the pedal lever 2 may be a lever of a lever or connecting rod mechanism that includes still other levers and that is coupled to the gas pedal. Moreover, the accelerator pedal module 1 includes a bearing block 4 as a retention structure for the pedal lever 2; this bearing block is preferably capable of being secured directly in the region of the driver's foot, by means of screw eyes 8 protruding laterally from a base plate 6 of the bearing block (see FIG. 2). Furthermore, the accelerator pedal module 1 may additionally be provided with a mechanical kick-down switch 10 for an automatic transmission of the motor vehicle, as described for instance in German Patent Disclosure DE 195 36 699 A1.

As seen from FIG. 2, the pedal lever 2 has a bearing portion 12, which is formed for instance by a shaft 14 that is press-fitted into a bore in the pedal lever 2. The shaft 14 includes two shaft journals 16, 18, protruding laterally away from the pedal lever 2 at a right angle and disposed for instance symmetrically, which with their radially outer circumferential surfaces, as bearing faces 20, 22, are retained in complementary bearing faces 24, 26 of the bearing block 4 pivotably about a pivot axis 28.

The pivoting motions of the pedal lever 2 relative to the bearing block 4 are converted by a rotary angle sensor 30 into an electrical signal, which represents the rotary angle of the pedal lever 2 relative to the bearing block 4. As the rotary angle sensor 30, at least one integrated Hall IC, which can detect a change in direction of a magnetic field, is preferably used. Such Hall ICs 30 are known for instance from EP 1 182 461 A2.

The Hall IC 30 is sheathed with a hot-melt adhesive in a sensor housing by a die-casting process, for instance, and secured to a printed circuit board 32, which extends perpendicular to the pivot axis 28 into a central recess 33 in the pedal lever 2 between the two shaft journals 16, 18 and can be connected via a plug connector 34 with pins to an electric line leading onward that carries the electrical signals on to an electronic evaluation unit. Alternatively, any sensor which can detect a change in the direction of a magnetic field can be used, such as a magnetoresistive sensor. The rotary angle sensor 30 is preferably disposed in the region of the pivot axis 28.

The magnetic field is generated by at least two bipolar magnets 36, 38, between which the Hall IC 30 is disposed symmetrically. As a result, the magnetic fields generated by each of the magnets 36, 38 act upon the rotary angle sensor 30 from two different sides and overlap and add together in an intersecting region, which means an advantageously high magnetic field intensity and high homogeneity of the magnetic field in the region of the sensor 30.

In a preferred way, the magnets are embodied as identical cylindrical magnet disks 36, 38 and are coaxial and parallel to one another; each magnet pole N and S is associated with one end of the disk plane, as can be seen from FIG. 3, which shows the magnet disk 36 from the standpoint of the Hall IC 30. In other words, a bipolar magnetization N, S exists on the face ends of the magnet disks 36, 38. Such a magnet 36, 38 is also referred to as being diametrically magnetized.

To make it possible to occupy the largest possible volume for generating a high magnetic field intensity within the circular cross sections of the two shaft journals 16, 18, the magnet disks 36, 38, for instance viewed in cross section, have two circumferential surface portions 39, diametrically opposed to the magnet poles N, S and embodied parallel to one another and rectilinearly and two arclike circumferential surface portions 41 disposed between them along the circumference.

Moreover, a center axis 43 extending perpendicular to the planes of the magnet disks 36, 38 is preferably coaxial with the pivot axis 28. The two magnet disks 36, 38 are injection molded, for instance by a single injection mold and a single production step, into the shaft journals 16, 18 in the course of a plastic injection molding process, in which only the edge of the magnet disks 36, 38 is for instance partially sheathed by the side face pointing toward the Hall IC 30, and the rest is left free (FIG. 3). During the plastic injection molding process, the magnet disks 36, 38 can be magnetized into permanent magnets, by means of magnet coils integrated into the injection mold.

FIG. 6 shows the course of the magnetic field lines 40, 42, which are generated by the two magnet disks 36, 38 and overlap in a central region, forming a plane of symmetry of the magnet disks 36, 38, in which region they have a high density and the Hall IC 30 is located. This Hall IC 30 contains one or more Hall elements, which may be disposed parallel or perpendicular to the magnetic field lines 40, 42 of the magnet disks 36, 38, depending on whether vertical or horizontal Hall elements are used. Horizontal Hall elements are sensitive to the component of the magnetic field that strikes their surface perpendicularly, while vertical Hall elements are sensitive to the component of the magnetic field that extends parallel to their surface. In addition, in accordance with the teaching of EP 1 182 461 A2, the Hall elements may be disposed on magnetic field concentrators of ferromagnetic material, which deflect the magnetic field lines in the region of a given Hall element in a direction that is favorable for the detection. Moreover, by experiments, Applicant has found that an especially homogeneous magnetic field is obtained if the magnet disks 36, 38 each have a recess 44, 46, respectively, on their side pointing toward the rotary angle sensor 30.

To generate a pedal-force-dependent hysteresis, for instance at least a portion of the circumferential surface of the shaft journals 16, 18 is provided with a friction lining, which cooperates with the associated bearing faces 24, 26 of the bearing block 4, as shown particularly in FIG. 4. Preferably, a friction lining 48 of this kind extends over approximately 170° on the circumference of the shaft journals 16, 18.

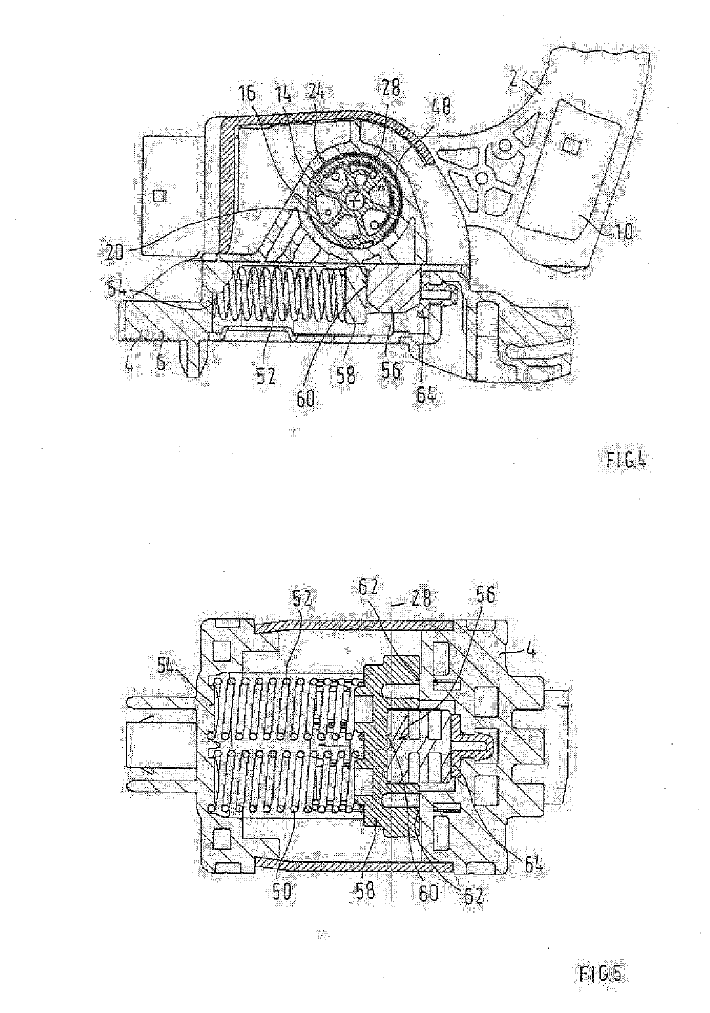

For safety reasons, the pedal lever 2 is prestressed into its outset position by at least two spring elements 50, 52, extending linearly and parallel to the base plate 6 of the bearing block 4, as show particularly in FIG. 5. The spring elements 50, 52 are preferably identical helical springs disposed parallel to one another, which are braced by one end on a support face 54 embodied on the bearing block and by their other end on a forward-protruding support arm 56 of the pedal lever 2 that with regard to the pivot axis 28 forms a lever arm. A pressure element 58 guided linearly in the tensing direction of the spring elements 50, 52 is located in the bearing block 4 between the support arm 56 of the pedal lever 2 and the other ends of the spring elements 50, 52.

The contact face of the support arm 56 of the pedal lever 2 with the pressure element 58 is embodied as a preferably spherical convex rolling face 60, so that the pressure element 58 can roll on this rolling face 60 when the pedal lever 2 is pivoted about the pivot axis 28 and as a result a slight radial relative motion takes place between the support arm 56 and the pressure element 58. Kinking of the spring elements 50, 52 upon being tensed during a pedal actuation can thus be prevented. This is because the linear compulsory guidance of the pressure element 58 in the bearing block dictates the tensing direction extending parallel to the center axes of the spring elements 50, 52. The transverse forces that occur as the support arm 56 rolls on the pressure element 58 are then dissipated into the bearing block 4 by the guides on which the pressure element 58 is guided and are not transmitted to the spring elements 50, 52, which are then free of transverse forces.

By the action of the pressure forces exerted by the spring elements 50, 52 in the outset position of the pedal lever 2, or in other words in an idling position, the pressure element 58 can be braced in such a way against one or more stops 62 embodied on the bearing block 4 that essentially no spring forces act on the pedal lever 2. In the outset position of the pedal lever 2, the spring forces are consequently braced in the bearing block 4 via the stops 62. In order nevertheless to keep the pedal lever 2 in a defined position in the outset position, the end face, pointing away from the spring elements 50, 52, of the support arm 56 of the pedal lever 2 is braced against a preferably elastic stop 64 held on the bearing block 4. Thus in the outset position the support arm 56 is disposed between the pressure element 58 and the stop 64 in a virtually force-free way. Upon actuation of the pedal lever 2, the support arm 56 shifts away from the stop 64 and, via the pressure element 58, tenses the spring elements 50. 52, which then exert a spring force, oriented counter to the actuation force, on the pedal lever 2.

1-16. (canceled)

17. In an accelerator pedal module for controlling the power of a drive motor or engine such as an internal combustion engine of a vehicle, the module having a pedal lever held rotatably on a bearing block for pivotable movement about pivot axis, and at least one sensor element for detecting the pivoting motion of the pedal lever relative to the bearing block, the improvement wherein, with the aid of the at least one sensor element a change in the direction of at least one magnetic field which change originates in the pivoting motion of the pedal lever relative to the bearing block is convertible into an electrical signal which represents the rotary angle of the pedal lever relative to the bearing block and the magnetic field is generated by at least two bipolar magnets between which the sensor element is disposed.

18. The accelerator pedal module as defined by claim 17, wherein the magnets are embodied as magnet disks and are magnetized diametrically with respect to a disk plane.

19. The accelerator pedal module as defined by claim 18, wherein the magnet disks are embodied identically and are disposed symmetrically with respect to the sensor element.

20. The accelerator pedal module as defined by claim 19, wherein the magnet disks are disposed coaxially and parallel with respect to one another.

21. The accelerator pedal module as defined by claim 20, wherein the center axes of the magnet disks are disposed coaxially with the pivot axis.

22. The accelerator pedal module as defined by claim 21 wherein the magnet disks each have a recess on their side pointing toward the sensor element.

23. The accelerator pedal module as defined by at least claim 18, wherein the magnet disks viewed in cross section, have two circumferential surface portions diametrically opposed to the magnet poles and embodied parallel to one another and rectilinearly, and two arclike circumferential surface portions disposed between the circumferential portions along the circumference of the discs.

24. The accelerator pedal module as defined by claim 18, wherein the sensor element includes at least one integrated Hall IC, with Hall elements which are disposed parallel to or perpendicular to the magnet disks.

25. The accelerator pedal module as defined by claim 18, wherein one magnet disk each is received in a respective journal pointing perpendicularly away from the pedal lever, of a shaft which is pivotably supported in the bearing block and is connected to the pedal lever in a manner fixed against relative rotation.

26. The accelerator pedal module as defined by claim 25, wherein the shaft comprises a central recess disposed between the shaft journals into which recess the sensor element which is connected to the bearing block, protrudes.

27. The accelerator pedal module as defined by claim 26, wherein one radially outer circumferential surface of each shaft journal forms a bearing face of the pedal lever.

28. The accelerator pedal module as defined by claim 11, wherein at least a portion of the circumferential surface of the shaft journals is provided with a friction lining, which cooperates with an associated bearing face of the bearing block.

29. The accelerator pedal module as defined by claim 17, further comprising at least one spring element prestressing the pedal lever into its outset position, which spring element is braced on one end on the bearing block and on its other end on a bracing portion of the pedal lever, and a pressure element linearly guided in the tensing direction of the spring element disposed in the bearing block between the bracing portion and the other end of the spring element, and wherein a rolling face of the bracing portion can be rolled along the pressure element.

30. The accelerator pedal module as defined by claim 18, further comprising at least one spring element prestressing the pedal lever into its outset position, which spring element is braced on one end on the bearing block and on its other end on a bracing portion of the pedal lever, and a pressure element linearly guided in the tensing direction of the spring element disposed in the bearing block between the bracing portion and the other end of the spring element, and wherein a rolling face of the bracing portion can be rolled along the pressure element.

31. The accelerator pedal module as defined by claim 19, further comprising at least one spring element prestressing the pedal lever into its outset position, which spring element is braced on one end on the bearing block and on its other end on a bracing portion of the pedal lever, and a pressure element linearly guided in the tensing direction of the spring element disposed in the bearing block between the bracing portion and the other end of the spring element, and wherein a rolling face of the bracing portion can be rolled along the pressure element.

32. The accelerator pedal module as defined by claim 20, further comprising at least one spring element prestressing the pedal lever into its outset position, which spring element is braced on one end on the bearing block and on its other end on a bracing portion of the pedal lever, and a pressure element linearly guided in the tensing direction of the spring element disposed in the bearing block between the bracing portion and the other end of the spring element, and wherein a rolling face of the bracing portion can be rolled along the pressure element.

33. The accelerator pedal module as defined by claim 21, further comprising at least one spring element prestressing the pedal lever into its outset position, which spring element is braced on one end on the bearing block and on its other end on a bracing portion of the pedal lever, and a pressure element linearly guided in the tensing direction of the spring element disposed in the bearing block between the bracing portion and the other end of the spring element, and wherein a rolling face of the bracing portion can be rolled along the pressure element.

34. The accelerator pedal module as defined by claim 29, wherein the pressure element is braced against at least one stop by the spring forces of the at least one spring element in the outset position of the pedal lever in such a way that essentially no spring forces act on the pedal lever.

35. The accelerator pedal module as defined by claim 29, wherein between the pressure element and the bearing block, two identical spring elements are disposed parallel to one another.

36. The accelerator pedal module as defined by claim 35, wherein, in the outset position the bracing portion of the pedal lever is braced against an elastic stop retained on the bearing block.
